(19) United States
(12) Patent Application Publication
(10) Pub. No.: US 2009/0300094 A1
(43) Pub. Date: Dec. 3, 2009

(54) SYSTEM AND METHOD FOR MARKETING AND COMMUNICATING INFORMATION

(76) Inventor: DANIEL B. ZURICH, Paramus, NJ (US)

Correspondence Address: NORRIS, MCLAUGHLIN & MARCUS, P.A., 875 THIRD AVE, 18TH FLOOR, NEW YORK, NY, 10022, US

(21) Appl. No.: 12/475,050

(22) Filed: May 29, 2009

Related U.S. Application Data
(60) Provisional application No. 61/057,051, filed on May 29, 2008.

(51) Int. Cl. G06F 15/16

(52) U.S. Cl. 709/202

(57) ABSTRACT

A system and method provide marketing and communicating for information. The system and method provide website launch software to a user terminal for automatically accessing, launching and/or displaying a provider website associated with a provider terminal over a network. The website launch software is stored on a computer software product or in an internal storage medium of the user terminal. The website launch software creates and installs a digital icon indicative of the provider onto a digital desktop of the user terminal. The digital icon is selectable or executable to automatically access and launch the provider website on the user terminal.

This application claims the benefit of U.S. Provisional Application Ser. No. 61/057,051, filed May 29, 2008.

### BACKGROUND

The present invention relates to a system and method for marketing and communicating information. More specifically, the system and method provide website launch software to a user terminal for automatically accessing, launching and/or displaying a provider website associated with a provider terminal over a network. The website launch software may stored on a computer software product or in an internal storage medium of the user terminal. The website launch software may create and install a digital icon indicative of the provider onto a digital desktop of the user terminal. The digital icon may be selected or executed to automatically access and launch the provider website on the user terminal.

Historically, computer users fumble and misspell when typing in Internet addresses. As a result, the user may get frustrated. Website developers rely on other means to market their sites to get users to “double-click” from other websites. Often, computer users do not remember email addresses at the time they need them. This causes aggravation, lost time and searching often sends them to your competitors' sites. Further, computer users do not save websites as favorites. Most computer users do not even know they have the ability to save websites as favorites. Websites are “intangible,” and therefore have little value to typical end users.

### SUMMARY

The present invention provides a simple, easy-to-use, and technically sophisticated website launch software for automatically access a provider website. The website launch software may launches a provider's website to user's terminals immediately and easily. The website launch software may installs a provider's website to user's terminals to foster brand recognition of the provider and enduring presence of the provider. The website launch software may be budget-affordable and provide a larger impactful than other marketing and advertising products, such as logo pens and the like.

In an embodiment of the present invention, a system for marketing and communicating information is provided. The system may have an user terminal connected to and in communication with a provider terminal via a data communication network. Further, the system may have a website launch software stored in a computer software product or an internal storage medium of the user terminal. Moreover, the system may have instructions provided by the website launch software to the user terminal, wherein the instructions automatically launch a provider website on the user terminal, wherein the provider website is stored in a database of the provider terminal.

In embodiments, the system may have a digital icon indicative of the provider website, wherein the digital icon is automatically installed on a digital desktop of the user terminal.

In another embodiment of the present invention, a method for marketing and communicating information is provided. The method may have a step of executing website launch software via a user terminal, wherein the website launch software is stored in a computer software product or an internal storage medium of the user terminal. Moreover, the method may have a step of automatically launching a provider website on the user terminal, wherein the provider website is stored in a database of a provider terminal and accessed over a data communication network.

In embodiments, the method may have a step of installing a digital icon onto a digital desktop of the user terminal, wherein the digital icon is indicative of the provider website and automatically launches the provider website when selected.

Additional features and advantages of the present invention are described in, and will be apparent from, the detailed description of the presently preferred embodiments and from the drawings.

### BRIEF DESCRIPTION OF THE DRAWINGS

FIG. 1 illustrates a black box diagram of a system for marketing and communicating information in an embodiment of the present invention.

FIG. 2 illustrates a flowchart for a method for for marketing and communicating information in an embodiment of the present invention.

### EMBODIMENTS

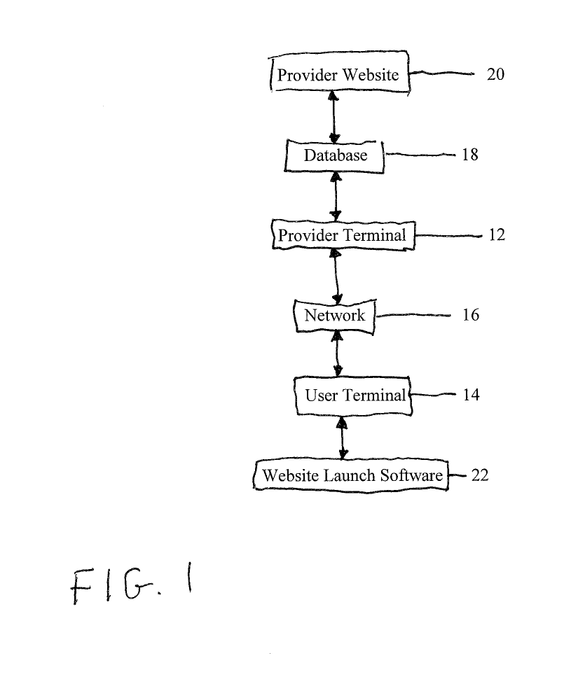

Referring now to the drawings wherein like numerals refer to like parts, FIG. 1 illustrates a system 10 for marketing and communicating information from a provider terminal 12 to a user terminal 14 via a data communication network 16 (hereinafter “the network 16”). The user terminal 14 may be connected to and/or may be in communication with the provider terminal 12 via the network 16. The user terminal 14 may be remote with respect to the provider terminal 12.

A database 18 may be connected to and/or may be in communication with the provider terminal 12 for delivering and/or for transmitting information to the provider terminal 12 and/or to the user terminal 14 via the first network 16. The database 18 may be remote to or may be local with respect to the provider terminal 12. A provider website 20 may be stored in and/or may be associated with the database 18. The provider website may include, contain and/or display information indicative of a provider (not shown in the drawings). The database 18 may be connected to and/or may be in communication with the provider terminal 12 for accessing and/or for delivering the information and/or the provider website 20 to the user terminal 14 via the network 16. As a result, the information and/or the provider website 20 may be accessed by and/or may be displayed 1 s by the user terminal 14 The provider terminal 12 and/or the user terminal 14 may be, for example, a computer terminal, a mobile device and/or an electronic device for receiving, processing, and/or displaying the information and/or the provider website 20 via the network 16. In an embodiment, the mobile device may be, for example, a 4G mobile device, a 3G mobile device, an internet protocol (hereinafter “IP”) video cellular telephone, an ALL-IP electronic device, a PDA, a laptop computer, a mobile cellular telephone, a satellite radio receiver, a portable digital audio player, a portable digital video player and/or the like. It should be understood that the provider terminal 12 and/or the user terminal 14 may be any terminal that may transmit, receive, process and/or display the information and/or the provider website 20 via the network 16 as known to one having ordinary skill in the art.

The network 16 may be a fixed network, such as, for example, a cabled network, a permanent network and/or the like. In an embodiment, the network 16 may be a temporary network, such as, for example, a modem network, a null modem network and/or the like. In an embodiment, the network 16 may be, for example, a local area network, a metropolitan area network, a wide area network, a personal area network and/or the like. Alternatively, the network 16 may be a wireless network, such as, for example, a wireless metropolitan area network, a wireless local area network, a wireless personal area network, a global standard network, a personal communication system network, a pager-based service network, a general packet radio service, a universal mobile telephone service network, a radio access network, a general-purpose packet-switched network and/or the like. The present invention should not be limited to a specific embodiment of the network 16. It should be understood that the network 16 may be any network that may deliver the information and/or the provider website 20 to the user terminal 14 as known to one having ordinary skill in the art.

The provider terminal 20 may be associated with and/or indicative of the provider. The provider website 20 may be indicative of goods and/or services which the provider may offer, sell and/or render. In embodiments, the goods of the provide may include consumer goods, durable goods, dry goods, hard goods, manufacture goods and/or non-manufactured goods. For example, the services of the provider may include industrial services, technical services, financial services, insurance services, educational services, transactional services, communication services, legal services, lending and/or crediting services, bank services, medical services, accounting services, financial services or the like. The provider website 20 may contain and/or may display service information associated with and/or based the provider and/or the professional services rendered by the provider. The present invention should not be deemed as limited to a specific type of goods and/or services offered, sold and/or rendered by the provider.

The system 10 may include website launch software 22 to launch or access the provider website 20 from the user terminal 14. For example, the website launch software 22 may be stored on a computer software product, such as, for example, a CD-ROM or the like. The computer software product be connected to the user terminal 14 or inserted into a disk drive (not shown in the drawings) of the user terminal 14. As a result, the user terminal 14 may execute the website launch software 22 stored on the computer software product. This computer software product may have exterior surfaces which may display indicia indicative of the website launch software 22. The indicia may include numerals, designs, insignias and/or words associated with, correspond to and/or based on the provider website 20 and/or the provider. The present invention should not be deemed as limited to a specific embodiment of the indicia displayable on the exterior surface of the computer software product.

Alternatively, the website launch software 22 may be stored in an internal storage medium (not shown in the drawings) of the user terminal 14 which may be accessed and executed by the user via a graphic user interface (not shown in the drawings) of the user terminal 14. In an other embodiment, the website launch software 22 may be accessed and/or retrieved from an e-mail, an internet website and/or a text message, such as, for example, short messaging or multimedia messaging services. It should be understood that the website launch software 22 may be stored on and accessed from any type of computer software product and/or internal storage medium as known to one of ordinary skill in the art.

The website launch software 22 may automatically instruct the user terminal 14 to launch of the provider website 20 via an internet browser utilized by the user terminal 14. The internet browser may be a default internet browser for the user terminal or may be an internet browser included within the website launch software 22. Moreover, the website launch software 22 may create and install a digital icon on a digital desktop (not shown in the drawings) displayable via the user terminal 14. The user may selected and execute the digital icon for the website launch software 22 from the digital desktop of the user terminal 14 via the graphic user interface. As a result, digital icon may instruct the user terminal 14 to automatically access and display the provide website 20 without further use of the website launch software 22. The icon may be customized to be indicative of the provider website 20 and/or the provider. The icon may include numerals, designs, insignias and/or words associated with, correspond to and/or based on the provider website 20 and/or the provider. The present invention is not deemed limited to a specific embodiment of the icon for the website launch software 22.

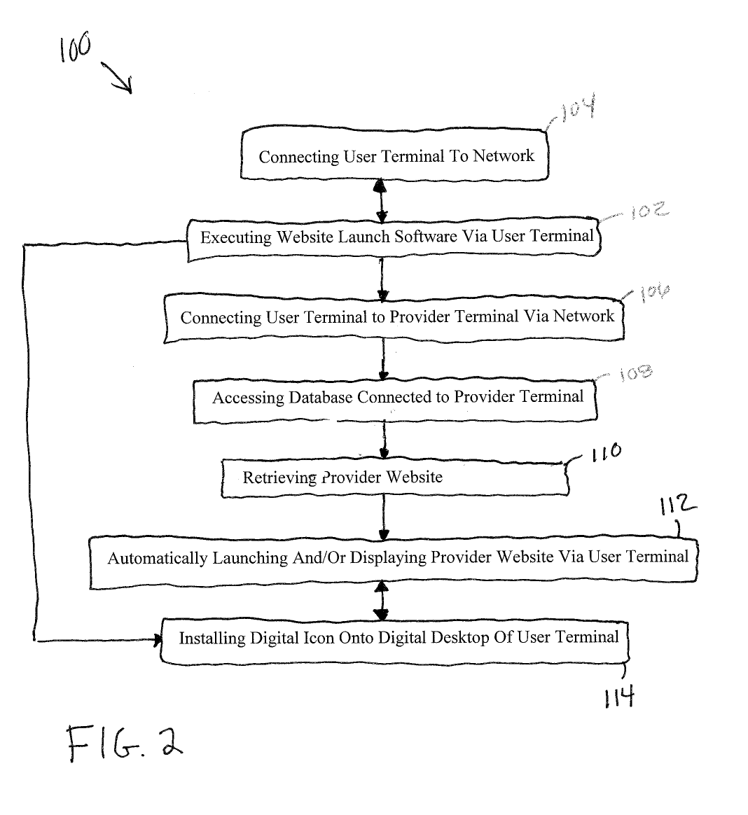

FIG. 2 illustrates a flowchart for a method 100 for marketing and communicating information and/or the website 20 from the provider terminal 12 to the user terminal 14 over the network 16. The user may select and/or execute the website launch software 22 via the user terminal 14 as shown at step 102. For example, the website launch software 22 may be stored on a CD-ROM which may be inserted into the disk drive of the user terminal 14 to execute the website launch software 22. Alternatively, the user may manipulate the graphic user interface of the user terminal 14 to access and execute the website launch software 22 stored in the internal storage medium of the user terminal 14. In an embodiment, the icon for the website launch software 22 may previously be installed on the digital desktop of the user terminal, and the user may access and execute the icon via the graphic user interface. As a result, the website launch software 22 may be executed by the user terminal 14.

The website launch software 22 may instruct the user terminal 14 to connect to and/or to be in communication with the network 16 as shown at step 104. Alternatively, the user terminal 14 may connect to and/or be in communication with the network 16 prior to the execution of the website launch software 22. The website launch software 22 may instruct the user terminal 14 to connect to and/or be in communication with the provider terminal 12 via the network 16 as shown at step 106. As a result, the user terminal 14 and the provider terminal 12 may be connected and/or in communication with each other.

The website launch software 22 may instruct the user terminal 14 to request access to the provider website 20 stored within the database 18 connected to the provider terminal 12. Pursuant to the request of the user terminal 14, the provider terminal 12 may access and/or retrieve the provider website 20 from the database 18 as shown in step 108. The provider terminal 12 may provide the user terminal 14 with access to the database 18 and/or the provider website 20. The user terminal 14 may access, retrieve and/or display the provider website 20 from the database 18 via the network 16 as shown at step 110. As a result of the user executing the website launch software 22, the user terminal 14 automatically launches the provider website 20 and/or displays the provider website 20 to the user as shown at step 112.

The website launch software 22 may create a digital icon indicative of the provider website 20 and/or the provider and install the digital icon on the digital desktop of the user terminal 14 as shown at step 114. In embodiments, the user may select and execute the website launch software 22 which may automatically create and install the digital icon to the digital desktop of the user terminal 14 as shown in FIG. 2. The digital icon for the website launch software 22 may be selected, accessed and/or executed by the user via the graphic user interface. As a result, the digital icon may instruct the user terminal 14 to automatically access, launch and/or display the provider website 20.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

I claim:

1. A system for marketing and communicating information, the system comprising:
an user terminal connected to and in communication with a provider terminal via a data communication network;
website launch software stored in a computer software product or an internal storage medium of the user terminal;
instructions provided by the website launch software to the user terminal, wherein the instructions automatically launch a provider website on the user terminal, wherein the provider website is stored in a database of the provider terminal.

2. The system according to claim 1, further comprising:
a digital icon indicative of the provider website, wherein the digital icon is automatically installed on a digital desktop of the user terminal.

3. A method for marketing and communicating information, the method comprising:
executing website launch software via a user terminal, wherein the website launch software is stored in a computer software product or an internal storage medium of the user terminal; and
automatically launching a provider website on the user terminal, wherein the provider website is stored in a database of a provider terminal and accessed over a data communication network.

4. A method according to claim 3, further comprising:
installing a digital icon onto a digital desktop of the user terminal, wherein the digital icon is indicative of the provider website and automatically launches the provider website when selected.
